(19) United States
(12) Patent Application Publication
(10) Pub. No.: US 2005/0119014 A1
(43) Pub. Date: Jun. 2, 2005

(54) Home cellular phone system

(76) Inventors: Howard Bandell, Lutherville, MD (US); Steven Bandell, Brooklyn, NY (US); Lester Bandell, Brooklyn, NY (US)

Correspondence Address: Mitchell B. Wasson, Esq.;HOFFMAN, WASSON & GITLER, PC, Suite 522, 2461 South Clark Street, Arlington, VA, 22202, US

(21) Appl. No.: 10/934,398

(22) Filed: Sep. 7, 2004

Related U.S. Application Data
(60) Provisional application No. 60/524,876, filed on Nov. 26, 2003.

(51) Int. Cl. H04Q 7/20

(52) U.S. Cl. 455/462; 455/461; 455/445; 455/567; 455/558

(57) ABSTRACT

A home or business cellular phone system including a base unit providing a wireless communications link between one or more receivers and an external caller through a master cellular unit. The master cellular unit is associated with the base unit. Electronics provided in the base unit or the master cellular unit would allow a link to be made between a remote caller and the wireless receivers.

This application is based upon U.S. provisional patent application Ser. No. 60/524,876, filed Nov. 26, 2003.

### FIELD OF THE INVENTION

The present invention relates to a home- or office-based telephone system employing one or more cellular phones, as well as one or more cordless/wireless phones.

### BACKGROUND OF THE INVENTION

During the last 50 years, the telecommunications industry has undergone unprecedented growth, both as to the number of callers and called parties, as well as to the type of services currently available to these parties. For many years, most homes and some business utilized only a single hard wired telephone to receive incoming calls, as well as to make outgoing calls. Since this system utilized a rotary dial, it was analog in nature and only voice communications between the parties were possible. With the advent of digital technology, the telecommunications industry has undergone marked changes in the last 20 years. These changes include the transmission of information digitally, such as voice communication, as well as other data. Additionally, a wireless communication system has been developed. While many homes still include a land line telephone system, this is generally augmented by one or more members of a household being provided with their own wireless cellular phone. As can be appreciated, the utilization of cellular phones, in many cases, by all of the members of a particular family, as well as the inclusion of the land line, would increase the cost to these families since each of the cellular phone numbers, as well as the land line, would require the payment of separate fees.

Several U.S. patents, as well as Patent Office publications, have addressed this problem. For example, U.S. Pat. Nos. 5,367,558 and 6,141,560, both issued to Gillig et al, disclose a cellular/cordless telephone system providing both cellular and cordless telephone services. Various embodiments are shown which include a cordless base station 180 and a cellular base station 190, as well as a control terminal 196. The system shown in these patents further operates so that a cellular/cordless telephone automatically operates as a cordless telephone whenever it is in the range of its corresponding base station.

U.S. Pat. No. 5,526,403, issued to Tam, discloses a wireless wireline interface and permits a cellular telephone transceiver to originate and receive calls using both cellular and wireline services. This is accomplished with a single subscriber device that has user specific personal information contained therein, which can be used to access both the cellular and the wireline networks. The apparatus for this operation includes a cellular transceiver, a handset, a wireline interface adapter and a duplex audio switch.

Published U.S. patent application 2003/0104809, to Godshaw et al, discloses a wireless network system for supporting at least one wireless instrument, such as a wireless cellular phone. The system includes a telephone cradle for the cellular phone, the cradle comprising a wireless local area network (WLAN) interface. The interface allows the cradle to communicate with a controller, which controller communications with a base station of a wireless communication network. The system contemplates two or more wireless cellular telephones, each having its own phone number and two or more cradles.

Published U.S. patent application 2002/0068529, to Knoble, details a system for adapting a standard telephone system in a home to be converted for cellular usage in order to avoid a redundant telephone service and its associated cost. A first connector is connected to a cellular phone and a second connector is connected is connected to the telephone system. A conversion unit is employed for converting signals received by the cellular phone to signals that emulate those of a public switch telephone network, and vice-versa.

A review of these references failed to disclose a telephone system employing a home base into which a cellular telephone is associated. This home base would allow telephone communication between this master cellular unit and various wireless receivers provided in a home or office environment.

### SUMMARY OF THE INVENTION

The aforementioned deficiencies in the prior art are addressed by the present invention which is directed to a phone system usable in a home or business environment wherein a cellular phone or cellular phones are used as the primary connection to the outside world. The cellular phones would replace hard wired or portable wireless telephones now in use in the home or business environment. The system would allow for the use of multiple cellular phones and wireless telephones. Additionally, the cellular phone or cellular phones may be taken on the road or any place outside the home or business without changing the system. These cellular phones are designated as master cellular phones and would operate in conjunction with a base unit and a number of wireless receivers which would be able to simultaneously relay voice and/or data to the multiple wireless receivers in the home or business. One embodiment would allow operation of the entire system even when the master cellular phone is not physically connected to the base unit.

The above and other features of the invention, including various novel details of constructions and combination of units, will now be more particularly described with reference to the accompanying drawings. It will understood that the particular devices and methods embodying the invention is shown by way of illustration only and not as limitations to the invention. The principles and features of this invention may be employed in varied and numerous embodiments without departing from the scope of the invention.

### BRIEF DESCRIPTION OF THE DRAWINGS

FIG. 1 is a block diagram showing the master cellular phone unit;

FIG. 2 is a block diagram showing a first embodiment of the entire home cellular phone system;

FIG. 3 is a block diagram showing one type of connection for the home cellular phone system;

FIG. 4 is a block diagram showing a second type of connection in the home cellular phone system;

FIG. 5 is a block diagram of the second embodiment of the present invention;

FIG. 6 is a block diagram showing the connection of the home cellular phone system used in the second embodiment of the present invention.

FIG. 7 is a block diagram showing a modified cellular telephone used in the system of the present invention; and

FIGS. 8-10 are flow diagrams showing the operation of the present invention.

### DETAILED DESCRIPTION OF THE INVENTION

The present invention is directed to a cellular phone system utilized in both the home and business environment. Although this is the case, for ease of explanation, we will refer to this system as a “home cellular phone system”. This home cellular phone system would enable a user to integrate one or more cellular phones into their home phone system, which in turn would include a number of wireless phones as well as an optional wired phone connection. The system would enable the user to utilize multiple phones, with multiple lines, but without having to subscribe to a wired system such as provided by AT&T, Bell Telephone, or the like. The cellular phone system would accept voice, data and video information, similar to units now on the market. However, the present invention would allow users to respond to cellular telephone calls by ringing at home or in the office, whether or not the portable cellular phone was active.

The home system would operate as if there were multiple lines when two or more cellular phones or cellular phone subscriber identity module (SIM) cards are plugged into a home base. The SIM cards will be usually supplied with a program by the cellular phone service provider to enable operation of the home cellular phone system without the need to plug the user's portable cellular phone into the system. It is noted that many cellular phones already utilize the SIM card to operate.

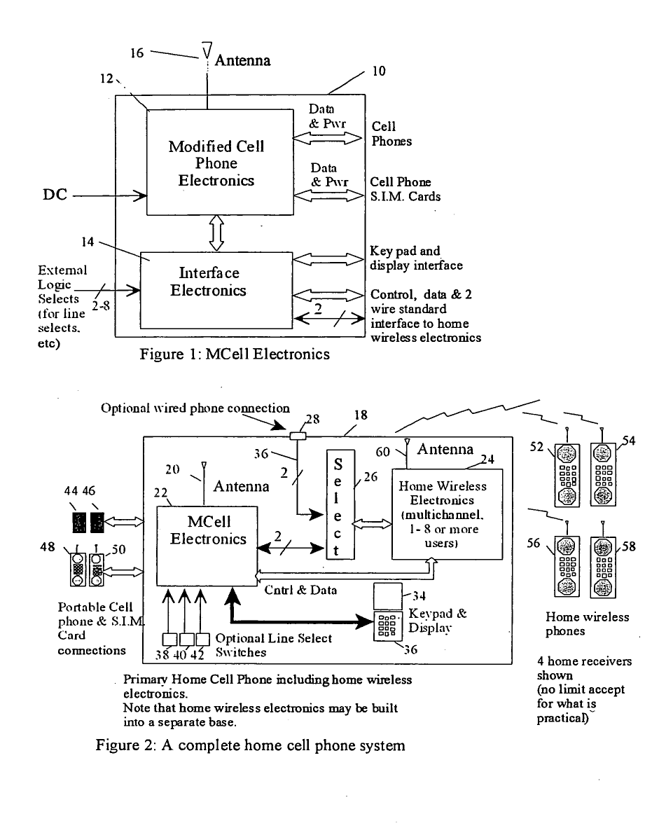

The aforementioned cellular phones which form the crux of the present invention are shown in FIGS. 1, 2 and 7 and would be denoted as the master cellular phone. This master cellular phone, otherwise characterized as a modified/enhanced cellular phone module (Mcell), can operate as a standard cellular phone, as well as being able to handle incoming and outgoing phone calls for two or more wireless phones by using time and/or code diversity. Additionally, with more electronic complexity, these cellular phones can act as two cellular independent phones in one location. A home base or master cellular unit 10 would be provided allowing one or more multiple cellular phones 48, 50 or multiple SIM cards 44, 46 plugged into the unit, as well as being able to simultaneously route voice and/or data to multiple wireless receivers in the home.

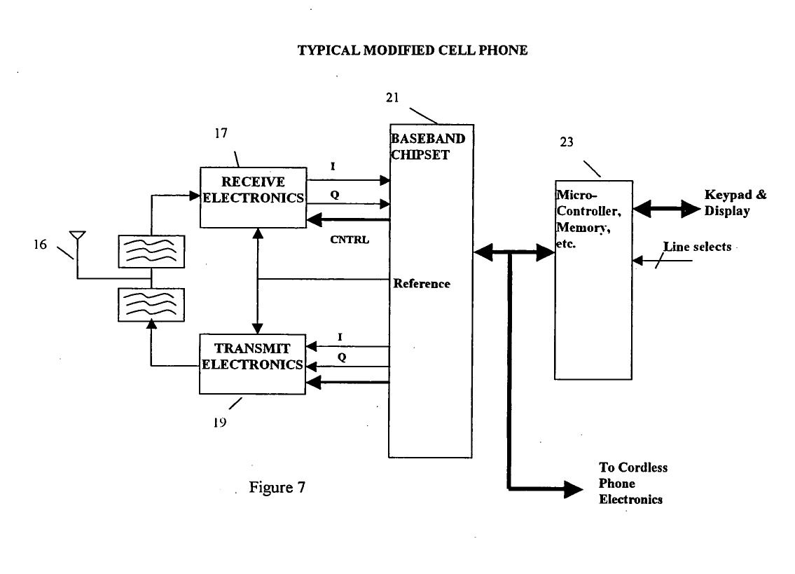

The master cellular unit 10 is shown in FIGS. 1 and 7. This cellular phone would include a modified cellular phone electronics unit 12 allowing incoming calls to be received, as well as outgoing calls to be made utilizing an antenna 16. An interface electronics unit 14 is in communication with the modified cellular phone electronics 12 thereby allowing the system to be used as a standard phone interface with one or more of the home wireless phones. The interface electronics 14 would allow the display and utilization of a keypad generally provided on the home base unit. Additionally, when the master cellular phone is attached to the home base unit, a source of power such as a DC plug would be used to both charge the master cellular phone, as well as to operate the entire system. The present invention contemplates the utilization of a multitude of wireless units, these units having the capacity of displaying data.

The master cellular unit 10 is shown in detail in FIG. 7. The antenna 16 is connected to an electronics section 17 utilized to receive information from the antenna 16 as well as an electronics unit 19 utilized to transmit information from the master cellular unit 10. Both electronic units 17 and 19 are also connected to a base-band chipset 21 which in turn is connected to a micro-controller as well as memory unit 23. The micro-controller as well as memory unit 23 are in turn connected to a standard keyboard and display used by the cellular phone.

It is important to note that various modifications for the master cellular unit would depend upon the cellular phone chipset chosen. These modifications would include, by not limited to, adding the ability to handle additional interfaces and real-time protocols between the cellular system and the cordless phone electronics. In the embodiment shown in FIG. 7, a micro-controller and additional memory 23 are added. Although most of the changes to the cellular system would be software in nature, this will not always be the case. The type of changes would generally depend upon the particular base-band chipset used and exactly how the designer/service provider would want the system to interact with the cellular system.

FIG. 2 illustrates a first embodiment of the home cellular phone system including a base unit 18 into which one or more master cellular units 48, 50 are plugged. Alternatively, a number of SIM cards 44, 46 could be utilized in lieu of one or more of the master cellular units 48, 50. It is noted that the master cellular unit would include an electronic section 22, as well as an interface electronics section 24 similar in nature as to the electronics units described with respect to FIG. 1. Alternatively, the electronics unit 22, as well as the interface electronics unit 24, may be built into the home base unit 18 or even into a separate unit. Each of the units 44, 46, 48 or 50 would have its own distinctive telephone number. Each of these telephone numbers could be associated with one or more of wireless phones 52, 54, 56 or 58, or they may all ring with a different tone or indicator for each different telephone numbers or lines. Alternatively, each of the wireless units 52, 54, 56 or 58 could be associated with only one of the portable cellular phone numbers or SIM card connections. An antenna 20 is attached to the home base unit 18 to provide wireless communication between the home base unit 18 and the cellular base station. Additionally, as is noted therein, the number of wireless units, as well as the number of cellular units, are not crucial to the present invention. The wireless phones or receivers 52, 54, 56 and 58 could be of identical design but would operate on different channels in the home wireless system. If more than one cellular phone or SIM card is plugged into the home base 18, the home phones 52, 54, 56 and 58 could be provided with a distinctive ring for each cellular phone number called. As shown in FIG. 2, a wired phone connection 28 could also be provided. This wired phone connection could also have a distinctive ring. The home wireless electronics unit 24, as well as the master cellular electronics unit 22 are connected to a select electronics unit 26 to allow the telephone call to be received by the proper wireless phone 52, 54, 56 or 58, as well as the wired phone connection 28. Additionally, this select unit 26 would also allow outgoing calls to be properly made. A plurality of line select switches 38, 40 and 42 would allow an operator to manually make the proper connections between the portable cellular phones or SIM connections 44, 46, 48 and 50 with the home wireless phones 52, 54, 56 and 58. A display 34 and keyboard 36 would also be provided in the base unit 18 for the purpose of transmitting and receiving digital information to be depicted upon the screen 34. A display could also be included in each of the cellular and wireless units. An antenna 60 is used to provide wireless communication between the interface electronics 24 and each of the wireless phones 52, 54, 56 and 58.

The multiple home receivers 52, 54, 56 and 58 may operate over a standard 800 MHz, 900 MHz, 1900 MHz, 2.4 GHz or any other wireless bands that typically do not require fees or a service provider. Presently, various home wireless technology for multiple receivers are in existence and have typically been used in the home to connect the hard wired Bell Telephone system to multiple wireless phones in the home using various analog or digital/TDMA communications technologies. These technologies could be utilized in the present invention, but different modulation schemes could also be employed.

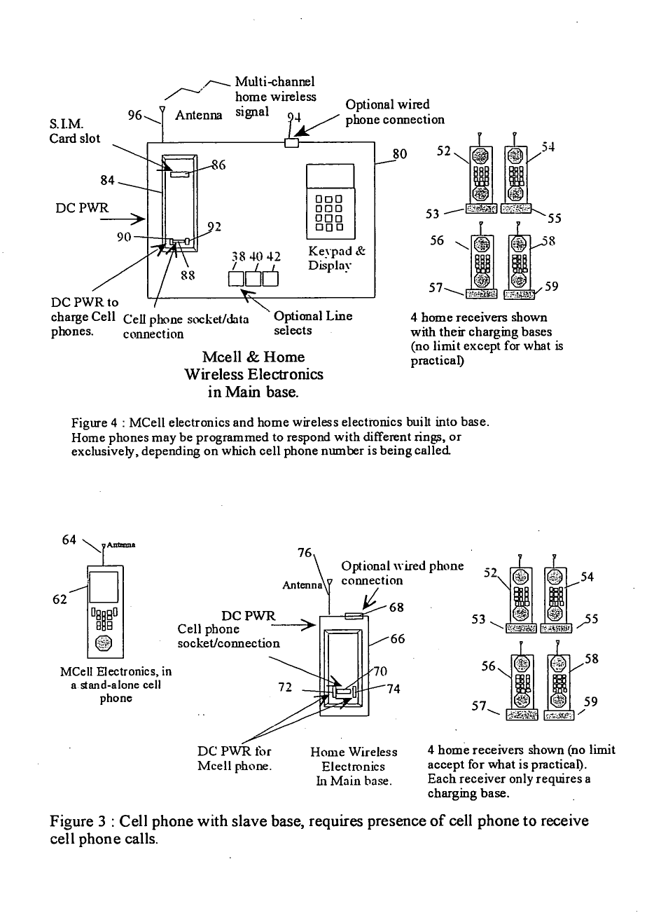

In the embodiment shown in FIG. 3, the master cellular phone 62 provided with an antenna 64 includes the cellular phone electronics 12 and interface electronics 14 (see FIG. 1) therein. A portion of a home base unit 66 is also shown in FIG. 3 into which the portable cellular unit 62 is connected utilizing a socket 70. Power for the operation of the cellular phone is provided by plugging the phone 62 into the sockets 72, 74. Additionally, an optional wired phone connection 68 is also provided, as is an antenna 76 for receiving and transmitting information from the home wireless phone 52, 54, 56 and 58. Each of the wireless receivers is provided in their own charging base 53, 55, 57 and 59, respectively. It is important to note that the embodiment shown in FIG. 3 would only operate if the master cellular unit 62 is plugged into the home base unit 66.

FIG. 4 illustrates an embodiment in which the electronics units 12, 14 are inserted directly into the home base unit 80, also including optional line selects 38, 40 and 42. Additionally, a plug-in unit 84 would be provided to plug the unit 62 (see FIG. 3) into the base unit 80. Although the unit 62 as described with respect with FIG. 3, included electronics units 12 and 14, the unit plugged into plug 84 need not include such electronics units. The plug 84 would include a socket 86 for the insertion of a SIM card, as well as power sockets 90, 92 and the cellular phone socket 88. The units shown in FIG. 4 would be able to employ either the SIM card or the cellular phone therein. Although the home base 80 is shown with respect to only one socket, it is noted that a multiple number of SIM cards or cellular phones could be utilized. Furthermore, as was true with respect to the embodiment shown in FIG. 3, a wired phone connection 94, as well as an antenna 96, would also be included.

The antenna 96 would be used to communicate information between the home base unit 80 and the wireless receivers 52, 54, 56 and 58. The antenna 64 (see FIG. 3) would receive information, as well as transmit information, to the outside world. Electronics connection with the home base unit would transmit information between the antenna associated with the home base unit and the antenna associated with the master cellular units. This would be true in all of the embodiments shown. The only exceptions to this rule, would be when the interface electronics unit provided in the cellular unit.

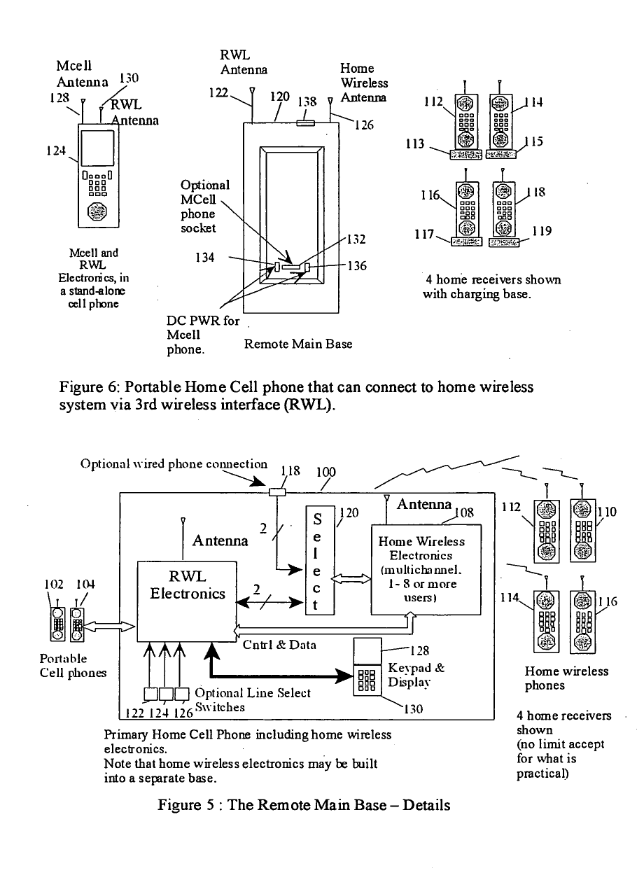

Another embodiment of the present invention is illustrated with respect to FIGS. 5 and 6. This embodiment would not require that the master cellular phone unit to be directly attached to the home base. The home base 10 would be provided with a robust wireless link (RWL) electronics 106, as well as the home wireless electronics 108 and the select unit 120. It is noted that the home wireless electronics unit 108 could also be provided in a separate base for contact with home wireless phones 110, 112, 114 and 116 provided in separate charging bases 113, 115, 117 and 119, respectively. The portable cellular phones 102 and 104 would be attached to the home base 100 in a manner similar to the unit shown in FIGS. 3 and 4. An optional wired phone connection 118 would be provided, as well as line select switches 122, 124 and 126. Additionally, a display 128, as well as a keypad 130 would also be included in the base unit 100.

Alternatively, as illustrated with respect to FIG. 6, a master cellular unit 124 would include both the electronics unit 12 (see FIG. 1), as well as the RWL electronics unit 106 (see FIG. 5). The unit 124 is provided with an antenna 128, as well as an RWL antenna 130. A base unit 120 would include a socket 132 into which the master cellular phone 124 would be attached. Additionally, power sockets 134, 136 would be included to provide power to the system. The base unit 120 would also be provided with an optional wired phone connection 138, as well as an RWL antenna 122 and a home wireless antenna 126.

The system shown in FIGS. 5 and 6 would allow the master cellular unit 124 to leave home for quite a distance and still allow the home wireless system to be fully operational. When the unit 124 receives a phone call, the user, by utilizing a certain input button or code, would allow the phone call to be forwarded to the base unit 110, 120. This trigger would produce a signal from the RWL antenna 130 on the unit 124 to the RWL antenna 122 on the base unit 110, 120. In this instance, a wireless transmission line would be created between the home wireless antenna 126 associated with the base unit 120 and any of the antennae associated with the wireless receivers 112, 114, 116 or 118. Once this wireless communications link is established, a link would be provided from the unit 124 to one of the receivers 112, 114, 116 or 118 through the base unit 120.

The present system in any of the embodiments, may be programmed with a unique enabling code of the user, given by a service provider in several ways. One way would be to plug the user's cellular phone into the base unit. Alternatively, a SIM card would be programmed by the service provider and plugged into the appropriate slot. Finally, the unit can be programmed by the service provider directly at the place of origin.

All of the embodiments described hereinabove, would allow both the home system and the portable cellular phones to be active at the same time, at the discretion of the service provider. This may be accomplished by withholding the SIM card, by a shut-down signal from the service provider's base station, or by any other reasonable method.

The fact that two cellular phone units with the same phone number may be active at the same time can be accomplished in many ways. One of these ways would be to provide a unique identification number in the home cellular phone system to identify itself as such to the service provider's base station. The only penalty that would be paid for such a system would be resources, as a 24 hour always-active home cellular phone system will tie up some system resources. Other protocols could also be employed.

With respect to FIGS. 5 and 6, it is noted that the home cellular phone system would be enabled as long as the master cellular unit is within range of the home unit utilizing the RWL link. In this instance, only one cellular phone unit per phone number can be active at any one time.

Additionally, with respect to the embodiment shown in FIGS. 5 and 6, if the master cellular unit 124 is removed from the base unit 110, 120, and a link has been established between the phone 124 and one of the home receivers 112, 114, 116 or 118, the user of the master unit 124 cannot turn off his phone until the home phone is also hung up and the RWL link automatically closes.

Furthermore, although the present invention is directed to generally a wireless link system, the main base station, as previously indicated, can have a wired phone connected thereto. While this would involve paying for two distinct services, it does give the advantages of giving the user the ability to make or receive cellular phone calls, as well as land based calls on their home phone system.

Although it is noted that the modified cellular phone electronics 12, as well as the RWL electronics 106 can be provided within the master cellular unit, if the electronics is mounted in the base unit as shown in FIGS. 2 and 5, there would be no high power RF radiation in the user's head or torso. Additionally, the base antenna may be made larger. Furthermore, the electronics may be made more sophisticated and not to be constrained to be of low power, thereby allowing the use of surface acoustic wavelength (SAW) filters to be used for better sensitivity and selectivity.

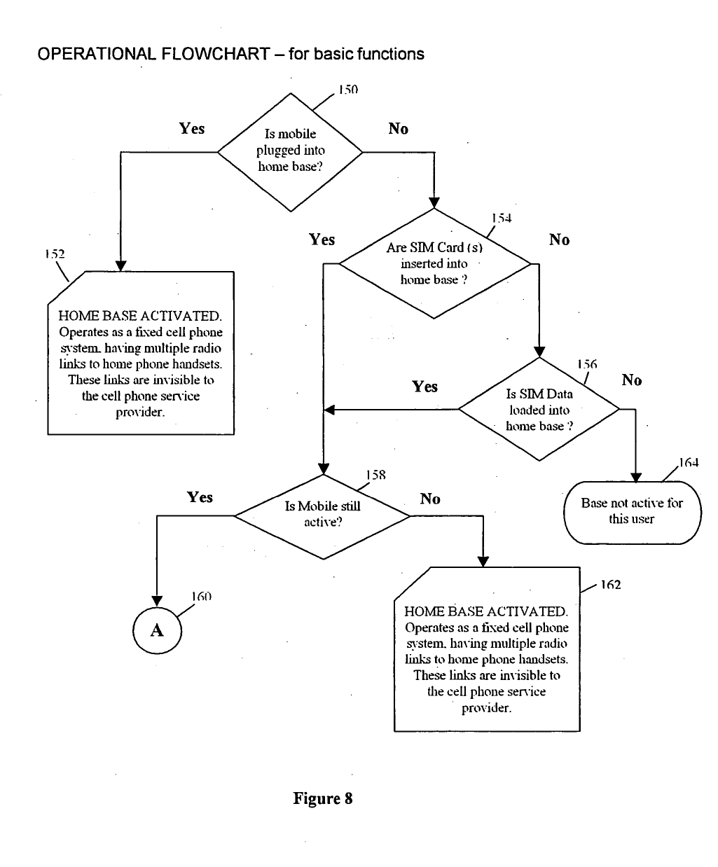

Referring to FIGS. 8-10, a flow diagram illustrating the operation of the present invention will now be described. Once a call is transmitted to the master cellular unit, a determination must be made by the system at step 150 whether the cellular unit is plugged into the home base. If this is the case, at step 152, the home base is activated and the entire system operates as a fixed cell phone having multiple radio links. If this is not the case, a determination is made at step 154 whether the SIM card or cards are inserted into the home base as shown in FIG. 2. If it is determined that the proper SIM card or cards are inserted into the home base, a determination is made at step 158 whether the cellular unit is active. If it is not active, at step 152, the home base would be activated similar to step 152 in which the home base operates as a fixed cell phone system, having multiple radial links. Similarly, if it is determined at step 154 that there is no SIM card inserted into the base, a determination must be made whether the data included in a SIM card was downloaded into the memory of the home base unit, if allowed by a provider. If this is the case, the system would proceed to step 158. If this was not the case, and the SIM card was determined not to be inserted into the home base, the base unit is not active for the user at step 164.

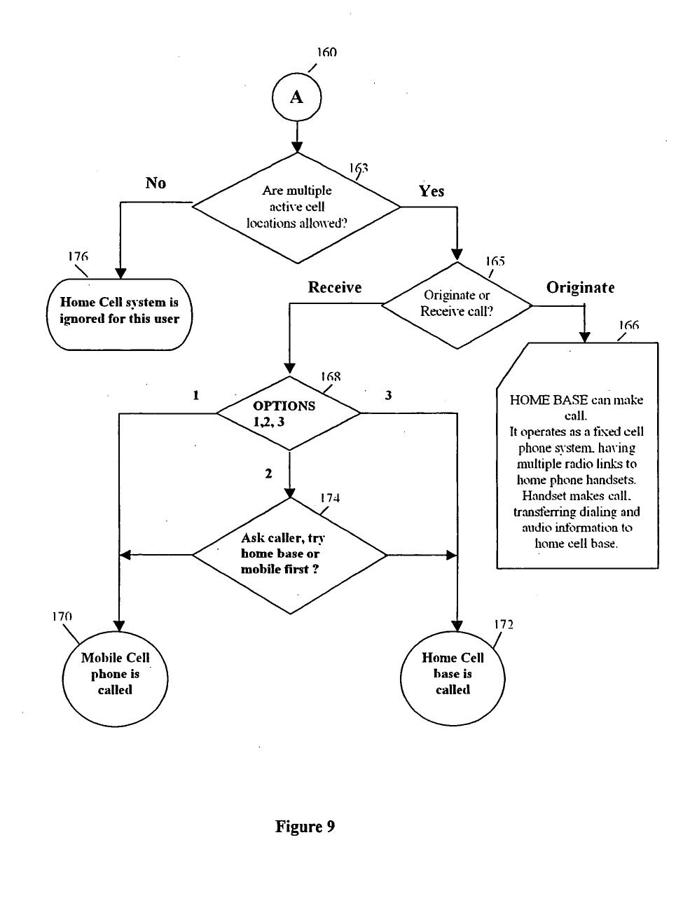

If, however, it is determined that the SIM card was inserted into the home base or the SIM data was loaded into home base, the system would proceed to box 160. At this point, as illustrated in FIG. 9, a determination is made at step 163 whether multiple active cell locations are allowed. If multiple active cell locations are not allowed, the home cell system is ignored for this user at step 176. On the other hand, if multiple active cell locations are allowed, a determination is made at step 164 whether the system is to originate or receive a call. If it is to originate a call, the home base at step 166, would make the call. In this instance, it would operate as a fixed cell phone system having multiple radio lengths. If it is determined at step 164 that a call is to be received, step 168 would determine whether the mobile cell phones called at step 170, the home cell base is called at step 172 or the caller is asked to try either the home base or the mobile phone accept 174.

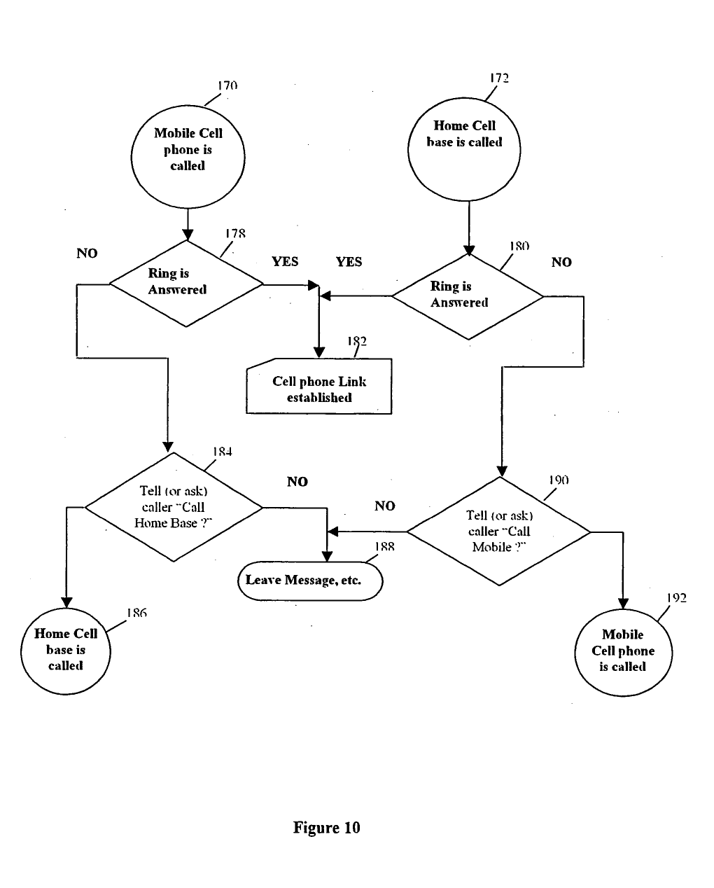

Referring to FIG. 10, if the mobile cell phone is called, the cell phone would ring at step 178. If the ring is not answered, a recorded announcement at 184 would indicate to the caller to call the home cell base at step 186. If the ring is answered, a cell phone link would be established at step 182.

Similarly, if the home cell base is called at step 172, a ring would be generated at step 180. If this ring was answered, the cell phone link would be established at step 182. However, if the ring is not answered, the caller would be asked, at step 190, to call the mobile cell phone at step 192. Alternatively, if the home base is not called at step 184, or the mobile cell phone is not called at step 190, the caller would have an option to leave a message at step 188.

It should be understood that various modifications within the scope of this invention can be made by one of ordinary skill in the art without departing from the spirit thereof.

1. A cellular phone system, comprising:
at least one cellular phone, each of said cellular phones provided with a first antenna;
a home base unit provided with a second antenna;
at least one wireless receiver, each of said wireless receivers provided with a third antenna;
a first electronics unit in communication with each of said first antenna for processing incoming phone calls and for processing outgoing phone calls;
a second electronics unit in communication with said second antenna for processing information received from said first electronics unit and said second antenna, thereby establishing a wireless communications link between said at least one cellular phone and said at least one wireless receivers through said home base.

2. The cellular phone system in accordance with claim 1, wherein said home base unit is provided with a socket for each of said at least one cellular phones, each of said cellular phones inserted in its respective socket during communication between one of said cellular phones and one of said wireless receivers, thereby allowing operation of the system when at least one of said cellular phones is inserted into one of said sockets.

3. The cellular phone system in accordance with claim 2, wherein said first and second electronics units are physically located in each of said cellular phones.

4. The cellular phone system in accordance with claim 2, wherein said first electronics unit is physically provided in each of said cellular phones and said second electronics unit is physically provided in said home base unit.

5. The cellular phone system in accordance with claim 1, wherein said first electronics unit is physically provided within each of said cellular phones allowing operation of the system when each of said cellular phones is unattached to said home base system.

6. The cellular phone system in accordance with claim 1, further including a land line connection to said home base unit.

7. The cellular phone system in accordance with claim 6, wherein each of said wireless receivers is provided with a ring tone distinguishable from the ring tone of the other wireless receivers.

8. The cellular phone system in accordance with claim 7, wherein said land line connection is provided with a ring tone distinguishable from all of said ring tones exhibited by each of said wireless receivers.

9. The cellular phone system in accordance with claim 1, wherein said home base unit is provided with at least one socket, and further including a SIM card inserted into at least one of said sockets, allowing communication between said at least one of said cellular phones and said at least one of said wireless receivers, regardless of whether said one of said cellular phones is physically connected to said home base unit.

10. The cellular phone system in accordance with claim 1, wherein said home base unit is provided with a memory having data therein allowing communication between said at least one of said cellular phones at said at least one of said wireless receivers, regardless of whether said one of said cellular phones is physically connected to said home base unit.
